(19) United States
(12) Patent Application Publication
(10) Pub. No.: US 2026/0202297 A1
(43) Pub. Date: Jul. 16, 2026

(54) METHOD FOR CALCULATING VAPOR DIFFUSION COEFFICIENT FOR BOUND WATER IN GLASS SAND POROUS MEDIA

(71) Applicant: HOHAI UNIVERSITY, Jiangsu (CN)

(72) Inventors: Zhi DOU, Jiangsu (CN); Jinguo WANG, Jiangsu (CN); Yun YANG, Jiangsu (CN); Zhou CHEN, Jiangsu (CN); Jianqiao ZHANG, Jiangsu (CN)

(73) Assignee: HOHAI UNIVERSITY, Jiangsu (CN)

(21) Appl. No.: 18/865,684

(22) PCT Filed: Mar. 19, 2024
(86) PCT No.: PCT/CN2024/082412

§ 371 Date: Nov. 14, 2024

(30) Foreign Application Priority Data
Dec. 22, 2023 (CN) 202311780209.X

(51) Int. Cl. G01N 13/00

(52) U.S. Cl. CPC G01N 13/00; G01N 2013/003

(57) ABSTRACT

Disclosed by the present disclosure is a method for calculating a vapor diffusion coefficient for bound water in a glass sand porous media. The method establishes a functional relation of the vapor diffusion coefficient for the bound water with respect to the evaporation rate of the bound water and the evaporation equivalent area of the bound water, in view of a process of the vapor diffusion of the bound water in the glass sand porous media, and then calculates the vapor diffusion coefficient for the bound water. The dynamic variations of the vapor diffusion coefficient for the bound water during the water evaporation process of the glass sand porous media are calculated by utilizing this method. The method provided by the present disclosure can achieve high accuracy, high reliability, and rapid acquisition of the vapor diffusion coefficient for the bound water.

### TECHNICAL FIELD

The present disclosure belongs to a technical field of groundwater dynamics in the unsaturated zone, and specifically relates to a method for calculating a vapor diffusion coefficient for bound water in a glass sand porous media.

### BACKGROUND

The diffusion coefficient is an important parameter that describes the transport capacity of water in the glass sand porous media. In a case where the situation relates to a calculation of the water diffusion coefficient of the glass sand porous media, experimental method and numerical simulation method are commonly used.

The experimental method calculates the water diffusion coefficient by measuring the actual diffusion rate of the water in the media, which can be implemented by using different experimental devices and techniques, such as measuring the water transport rate through the media. However, the experimental method requires a significant amount of time and resources as a large number of experiments are required to obtain sufficient data for analysis. In addition, limitations on experimental conditions can also affect the feasibility of the experiments, such as controlling factors such as temperature, humidity, and pressure.

On the other hand, the numerical simulation method utilizes mathematical models and computers to simulate the diffusion processes of the water in the media, which can calculate the water diffusion coefficient by establishing a mathematical model of the media structure and water transport, and then using a computer to simulate the water diffusion process. However, the numerical simulation method requires accurate mathematical models and high-performance computers for simulation, with high computational complexity and longer computation time.

Therefore, although these methods have certain applications in the calculations of the water diffusion coefficient, taking bound water as the main controlling factor for vapor diffusion is ignored, and the calculation on diffusion coefficient in this method is mainly focused on the overall pore water. In addition, problems such as limited experimental conditions, high time and resource consumption, and high computational complexity are particularly significant. Therefore, the further research and development of more efficient and accurate calculation methods are required to address these problems.

### SUMMARY

Objectives of the present disclosure: The present disclosure provides a method for calculating a vapor diffusion coefficient for bound water in a glass sand porous media, which solves the technical problems of the inability to consider the dynamic variations of the vapor diffusion coefficient for the bound water, the low accuracy, and the poor reliability in the prior art.

Technical solutions: in order to solve the above technical problems, the present disclosure provides a method for calculating a vapor diffusion coefficient for bound water in a glass sand porous media, and the method specifically includes following steps.
In Step 1, a total evaporation rate of the glass sand porous media and an evaporation rate of the bound water in the glass sand porous media are calculated.
In Step 2, an evaporation equivalent area of the bound water in the glass sand porous media is calculated according to the total evaporation rate of the glass sand porous media and the evaporation rate of the bound water in the glass sand porous media.
In Step 3, a dynamic relation between the evaporation rate of the bound water in the glass sand porous media and the evaporation equivalent area of the bound water in the glass sand porous media is established, and a functional relation is constructed, with the vapor diffusion coefficient for the bound water in the glass sand porous media as a dependent variable, and the evaporation rate of the bound water in the glass sand porous media as well as the evaporation equivalent area of the bound water in the glass sand porous media as independent variables.
In Step 4, the vapor diffusion coefficient for the bound water is calculated under a given condition of the evaporation rate of the bound water and the evaporation equivalent area of the bound water according a functional relation of the vapor diffusion coefficient for the bound water with respect to the evaporation rate of the bound water and the evaporation equivalent area of the bound water.

Further, in Step 1, a method for calculating the total evaporation rate of the glass sand porous media and the evaporation rate of the bound water in the glass sand porous media is as follows:

$$e = V ( \partial θ / \partial t ) \\ {e}_{b} = V ( \partial {θ}_{b} / \partial t )$$

where e denotes the total evaporation rate, e_{b} denotes the evaporation rate of the bound water, V denotes a volume of the glass sand porous media, θ denotes a water content of a total volume, θ_{b} denotes a water content of a bound water volume, t denotes an evaporation time, ∂θ/∂t denotes a variation of the water content of the total volume relative to the evaporation time, and ∂θ_{b}/∂t denotes a variation of the water content of the bound water volume relative to the evaporation time.

Further, in Step 2, a method for calculating the evaporation equivalent area of the bound water in the glass sand porous media according to the total evaporation rate of the glass sand porous media and the evaporation rate of the bound water in the glass sand porous media is as follows:

$${A}_{v} = A \cdot φ \cdot ξ - \frac{( e - {e}_{b} ) \partial t}{\partial ( \frac{2 σcosα}{\text{?}} )}$$

where, Aᵥ denotes the evaporation equivalent area of the bound water, A denotes an actual surface area of the glass sand porous media, φ denotes a porosity of the glass sand porous media, ξ denotes an empirical reduction coefficient, σ denotes an interfacial tension of water, α denotes a contact angle between the water and a glass sand surface, ρ_{w} denotes a density of the water, g denotes a gravitational acceleration, r̅_̅{̅f̅}̅ denotes an average pore size of free water, and

$$\partial ( \frac{2 σ cos α}{\text{?}} )$$

denotes a variation of a capillary rise height.

Further, in Step 3, a method for establishing a dynamic relation between the evaporation rate of the bound water in the glass sand porous media and the evaporation equivalent area of the bound water in the glass sand porous media is as follows:

$${e}_{b} = D \frac{\partial C}{\partial z} = D \frac{{C}_{1} - {C}_{∞}}{V \cdot H} {A}_{v}$$

where D denotes the vapor diffusion coefficient for the bound water, C₁ denotes an initial vapor concentration during an evaporation process, C_{∞} denotes a vapor concentration when the evaporation process is terminated, Aᵥ denotes the evaporation equivalent area of the bound water, and H denotes a height of the glass sand porous media.

A method for constructing a functional relation with the vapor diffusion coefficient for the bound water in the glass sand porous media as a dependent variable, and the evaporation rate of the bound water in the glass sand porous media as well as the evaporation equivalent area of the bound water in the glass sand porous media as independent variables is as follows:

$$D ( {e}_{b} , {A}_{v} ) = \frac{{e}_{b} \cdot V \cdot H}{( {C}_{1} - {C}_{∞} )} \cdot \frac{1}{{A}_{v}} = \frac{{e}_{b} \cdot V \cdot H}{( {C}_{1} - {C}_{∞} )} \cdot [ 1 / ( A \cdot φ \cdot ξ - \frac{( e - {e}_{b} ) \partial t}{\partial ( \frac{2 σcosα}{\text{?}} )} ) ] .$$

Further, in Step 4, by the constructed functional relation of the vapor diffusion coefficient for the bound water with respect to the evaporation rate of the bound water and the evaporation equivalent area of the bound water, under a given condition of the evaporation rate of the bound water and a vapor diffusion area of the bound water, the vapor diffusion coefficient for the bound water in the glass sand porous media is obtained by substituting the evaporation rate of the bound water and a vapor diffusion area of the bound water into the functional relation.

The beneficial effects: in comparison with the prior art, the technical solutions of the of the present disclosure have following beneficial effects.
(1) The method for calculating the vapor diffusion coefficient for the bound water in the glass sand porous media provided in the embodiments of the present disclosure theorizes the calculation of the dynamic variations of the vapor diffusion coefficient for the bound water, enabling the method to be generalizable, and the method implements the calculation of the dynamic variations of the vapor diffusion coefficient for the bound water, with merely requiring the parameters such as the evaporation rate, the vapor concentration, the surface area, and the porosity, and solves the technical problems of the inability to consider the dynamic variations of the vapor diffusion coefficient for the bound water, the low accuracy, and the poor reliability in the prior art, and can acquire the results rapidly.
(2) The method for calculating the vapor diffusion coefficient for the bound water in the glass sand porous media provided by the present disclosure calculates the vapor diffusion coefficient for the bound water by constructing a model of a physical process of the vapor diffusion of the bound water based on the accurate measurements on the bound water during the evaporation process of the glass sand porous media, which eliminates the disadvantages of the inability to calculate the diffusion coefficient in view of the process of the vapor diffusion of the bound water, with high accuracy and strong reliability.

### BRIEF DESCRIPTION OF THE DRAWINGS

FIG. 1 illustrates a flow chart diagram of a method for calculating a vapor diffusion coefficient for bound water in a glass sand porous media provided by one embodiment of the present disclosure.

FIG. 2 illustrates a dynamic variation situation of the vapor diffusion coefficient for the bound water provided by one embodiment of the present disclosure.

### DETAILED DESCRIPTION OF THE EMBODIMENTS

The specific implementations of the present disclosure will be clarified in details in conjunction with the accompanying drawings and the embodiments. It should be noted that the following embodiments are merely used to illustrate the technical solutions of the present disclosure and not intended to limit the protection scope of the present disclosure.

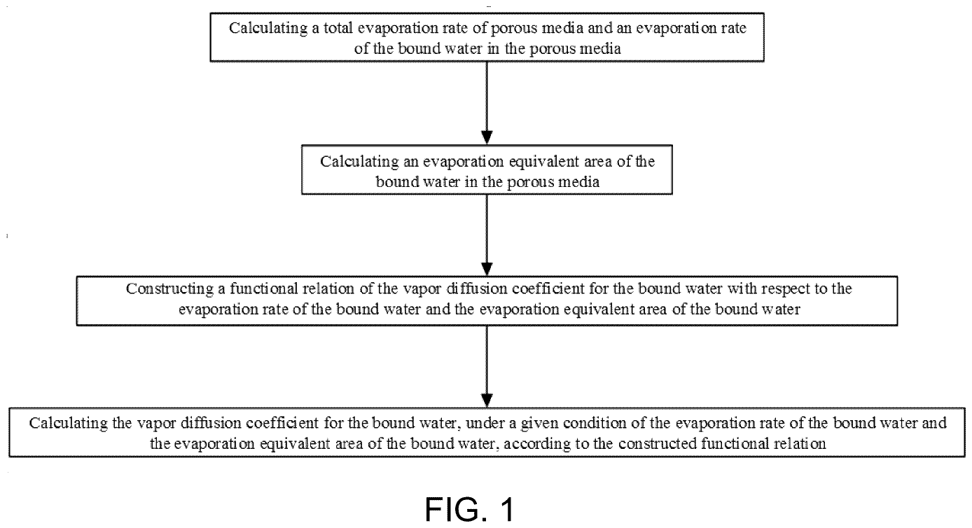

As illustrated in FIG. 1, the present disclosure provides a method for calculating a vapor diffusion coefficient for bound water in a glass sand porous media, and the method specifically includes following steps.
In Step 1, a total evaporation rate of the glass sand porous media and an evaporation rate of the bound water in the glass sand porous media are calculated.
In Step 2, an evaporation equivalent area of the bound water in the glass sand porous media is calculated according to the total evaporation rate of the glass sand porous media and the evaporation rate of the bound water in the glass sand porous media.
In Step 3, a dynamic relation between the evaporation rate of the bound water in the glass sand porous media and the evaporation equivalent area of the bound water in the glass sand porous media is established, and a functional relation is constructed, with the vapor diffusion coefficient for the bound water in the glass sand porous media as a dependent variable, and the evaporation rate of the bound water in the glass sand porous media as well as the evaporation equivalent area of the bound water in the glass sand porous media as independent variables.
In Step 4, the vapor diffusion coefficient for the bound water is calculated under a given condition of the evaporation rate of the bound water and the evaporation equivalent area of the bound water, according a functional relation of the vapor diffusion coefficient for the bound water with respect to the evaporation rate of the bound water and the evaporation equivalent area of the bound water.

Further, in Step 1, a method for calculating the total evaporation rate of the glass sand porous media and the evaporation rate of the bound water in the glass sand porous media is as follows:

$$e = V ( \partial θ / \partial t ) \\ {e}_{b} = V ( \partial {θ}_{b} / \partial t )$$

where e denotes the total evaporation rate, e_{b} denotes the evaporation rate of the bound water, V denotes a volume of the glass sand porous media, θ denotes a water content of a total volume, θ_{b} denotes a water content of a bound water volume, t denotes an evaporation time, ∂θ/∂t denotes a variation of the water content of the total volume relative to the evaporation time, and ∂θ_{b}/∂t denotes a variation of the water content of the bound water volume relative to the evaporation time.

Further, in Step 2, a method for calculating the evaporation equivalent area of the bound water in the glass sand porous media according to the total evaporation rate of the glass sand porous media and the evaporation rate of the bound water in the glass sand porous media is as follows:

$${A}_{v} = A \cdot φ \cdot ξ - \frac{( e - {e}_{b} ) \partial t}{\partial ( \frac{2 σcosα}{\text{?}} )}$$

where, Aᵥ denotes the evaporation equivalent area of the bound water, A denotes an actual surface area of the glass sand porous media, φ denotes a porosity of the glass sand porous media, ξ denotes an empirical reduction coefficient, σ denotes an interfacial tension of water, α denotes a contact angle between the water and a glass sand surface, ρ_{w} denotes a density of the water, g denotes a gravitational acceleration, r̅_̅{̅f̅}̅ denotes an average pore size of free water, and

$$\partial ( \frac{2 σ cos α}{\text{?}} )$$

denotes a variation of a capillary rise height.

Further, in Step 3, a method for establishing a dynamic relation between the evaporation rate of the bound water in the glass sand porous media and the evaporation equivalent area of the bound water in the glass sand porous media is as follows:

$${e}_{b} = D \frac{\partial C}{\partial z} = D \frac{{C}_{1} - {C}_{∞}}{V \cdot H} {A}_{v}$$

where D denotes the vapor diffusion coefficient for the bound water, C₁ denotes an initial vapor concentration during an evaporation process, C_{∞} denotes a vapor concentration when the evaporation process is terminated, Aᵥ denotes the evaporation equivalent area of the bound water, and H denotes a height of the glass sand porous media.

A method for constructing a functional relation with the vapor diffusion coefficient for the bound water in the glass sand porous media as a dependent variable, and the evaporation rate of the bound water in the glass sand porous media as well as the evaporation equivalent area of the bound water in the glass sand porous media as independent variables is as follows:

$$D ( {e}_{b} , {A}_{v} ) = \frac{{e}_{b} \cdot V \cdot H}{( {C}_{1} - {C}_{∞} )} \cdot \frac{1}{{A}_{v}} = \frac{{e}_{b} \cdot V \cdot H}{( {C}_{1} - {C}_{∞} )} \cdot [ 1 / ( A \cdot φ \cdot ξ - \frac{( e - {e}_{b} ) \partial t}{\partial ( \frac{2 σcosα}{\text{?}} )} ) ] .$$

Further, in Step 4, by the constructed functional relation of the vapor diffusion coefficient for the bound water with respect to the evaporation rate of the bound water and the evaporation equivalent area of the bound water, under a given condition of the evaporation rate of the bound water and a vapor diffusion area of the bound water, the vapor diffusion coefficient for the bound water in the glass sand porous media is obtained by substituting the evaporation rate of the bound water and a vapor diffusion area of the bound water into the functional relation.

The actual calculating examples

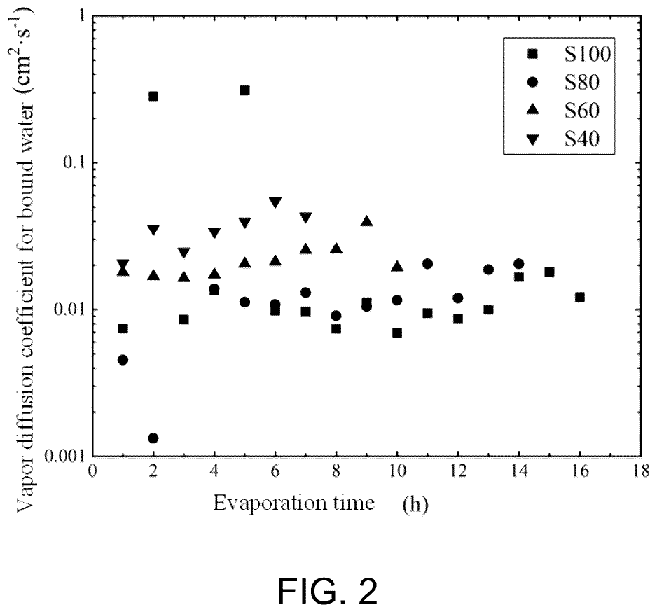

In the experiments, the glass sand with a mesh size of 30 and a particle size that ranges from 0.6 to 0.8 mm is selected as the sample material, Given the physical property parameters of the sample, the samples of the glass sand porous media with saturation levels of 100%, 80%, 60%, and 40% are respectively prepared for the evaporation experiments. According to a method for calculating a vapor diffusion coefficient for bound water in a glass sand porous media provided by the present disclosure, the dynamic variations obtained are as illustrated in FIG. 2. In general, in a case where the vapor diffusion is described according to Fick's law, D is considered as a constant. However, according to the method provided in this embodiment, D is not constant during the evaporation process, but slightly increases with the increase of the evaporation time. However, the overall variations of D during the evaporation process are extremely little. Thus, in a case of describing the process of the vapor diffusion of the bound water, it is feasible to consider D as a constant. But in order to accurately describe the migration rules during the process of the vapor diffusion of the bound water, the variations of D must be considered, and the variations of D is that the higher the degree of the unsaturation, the larger the corresponding variations, which indicates that the enhancements of the degree of the unsaturation promote the migrations of the bound water through the vapor diffusion.

The objectives, the technical solutions and the beneficial effects of the present disclosure are further clarified in details through the above-mentioned specific embodiments, it should be understood that the above are merely specific embodiments of the present disclosure and are not intended to limit the protection scope of the present disclosure. All modifications, equivalent substitutions, improvements, and the like made within the spirit and principles of the present disclosure should be included within the protection scope of the present disclosure.

1. A method for calculating a vapor diffusion coefficient for bound water in a glass sand porous media, wherein the method comprises following steps:
Step 1, calculating a total evaporation rate of the glass sand porous media and an evaporation rate of the bound water in the glass sand porous media;
Step 2, calculating, according to the total evaporation rate of the glass sand porous media and the evaporation rate of the bound water in the glass sand porous media, an evaporation equivalent area of the bound water in the glass sand porous media;
Step 3, establishing a dynamic relation between the evaporation rate of the bound water in the glass sand porous media and the evaporation equivalent area of the bound water in the glass sand porous media, and constructing a functional relation with the vapor diffusion coefficient for the bound water in the glass sand porous media as a dependent variable, and the evaporation rate of the bound water in the glass sand porous media as well as the evaporation equivalent area of the bound water in the glass sand porous media as independent variables; and
Step 4, calculating, under a given condition of the evaporation rate of the bound water and the evaporation equivalent area of the bound water, the vapor diffusion coefficient for the bound water, according a functional relation of the vapor diffusion coefficient for the bound water with respect to the evaporation rate of the bound water and the evaporation equivalent area of the bound water.

2. The method for calculating the vapor diffusion coefficient for the bound water in the glass sand porous media according to claim 1, wherein in Step 1, a method for calculating the total evaporation rate of the glass sand porous media and the evaporation rate of the bound water in the glass sand porous media is:
$$e = V ( \partial θ / \partial t ) \\ {e}_{b} = V ( \partial {θ}_{b} / \partial t )$$
where e denotes the total evaporation rate, e_{b} denotes the evaporation rate of the bound water, V denotes a volume of the glass sand porous media, θ denotes a water content of a total volume, θ_{b} denotes a water content of a bound water volume, t denotes an evaporation time, ∂θ/∂t denotes a variation of the water content of the total volume relative to the evaporation time, and ∂θ_{b}/∂t denotes a variation of the water content of the bound water volume relative to the evaporation time.

3. The method for calculating the vapor diffusion coefficient for the bound water in the glass sand porous media according to claim 2, wherein in Step 2, a method for calculating the evaporation equivalent area of the bound water in the glass sand porous media according to the total evaporation rate of the glass sand porous media and the evaporation rate of the bound water in the glass sand porous media is:
$${A}_{v} = A \cdot φ \cdot ξ - \frac{( e - {e}_{b} ) \partial t}{\partial ( \frac{2 σcosα}{\text{?}} )}$$
where, Aᵥ denotes the evaporation equivalent area of the bound water, A denotes an actual surface area of the glass sand porous media, φ denotes a porosity of the glass sand porous media, ξ denotes an empirical reduction coefficient, σ denotes an interfacial tension of water, α denotes a contact angle between the water and a glass sand surface, ρ_{w} denotes a density of the water, g denotes a gravitational acceleration, r̅_̅{̅f̅}̅ denotes an average pore size of free water, and
$$\partial ( \frac{2 σ cos α}{\text{?}} )$$
denotes a variation of a capillary rise height.

4. The method for calculating the vapor diffusion coefficient for the bound water in the glass sand porous media, wherein in Step 3, a method for establishing a dynamic relation between the evaporation rate of the bound water in the glass sand porous media and the evaporation equivalent area of the bound water in the glass sand porous media is:
$${e}_{b} = D \frac{\partial C}{\partial z} = D \frac{{C}_{1} - {C}_{∞}}{V \cdot H} {A}_{v}$$
where D denotes the vapor diffusion coefficient for the bound water, C₁ denotes an initial vapor concentration during an evaporation process, C_{∞} denotes a vapor concentration when the evaporation process is terminated, Aᵥ denotes the evaporation equivalent area of the bound water, and H denotes a height of the glass sand porous media; and
a method for constructing a functional relation with the vapor diffusion coefficient for the bound water in the glass sand porous media as a dependent variable, and the evaporation rate of the bound water in the glass sand porous media as well as the evaporation equivalent area of the bound water in the glass sand porous media as independent variables is:
$$D ( {e}_{b} , {A}_{v} ) = \frac{{e}_{b} \cdot V \cdot H}{( {C}_{1} - {C}_{∞} )} \cdot \frac{1}{{A}_{v}} = \frac{{e}_{b} \cdot V \cdot H}{( {C}_{1} - {C}_{∞} )} \cdot [ 1 / ( A \cdot φ \cdot ξ - \frac{( e - {e}_{b} ) \partial t}{\partial ( \frac{2 σcosα}{\text{?}} )} ) ] .$$

5. The method for calculating the vapor diffusion coefficient for the bound water in the glass sand porous media according to claim 4, wherein in Step 4, by the constructed functional relation of the vapor diffusion coefficient for the bound water with respect to the evaporation rate of the bound water and the evaporation equivalent area of the bound water, under a given condition of the evaporation rate of the bound water and a vapor diffusion area of the bound water, the vapor diffusion coefficient for the bound water in the glass sand porous media is obtained by substituting the evaporation rate of the bound water and a vapor diffusion area of the bound water into the functional relation.
